(19) United States
(12) Patent Application Publication
(10) Pub. No.: US 2020/0348553 A1
(43) Pub. Date: Nov. 5, 2020

(54) LIQUID CRYSTAL DISPLAY AND METHOD OF MANUFACTURING THE SAME

(71) Applicant: Samsung Display Co., Ltd., Yongin-si (KR)

(72) Inventors: Won Jun LEE, Changwon-si (KR); You Sik SHIN, Suwon-si (KR); Youn Hak JEONG, Cheonan-si (KR); Hak Sun CHANG, Yongin-si (KR); Jin Joo HA, Hwaseong-si (KR)

(21) Appl. No.: 16/790,482

(22) Filed: Feb. 13, 2020

(30) Foreign Application Priority Data
May 3, 2019 (KR) 10-2019-0052398

(51) Int. Cl. G02F 1/1362; G02F 1/1368; G09G 3/36

(52) U.S. Cl. CPC G02F 1/13624; G02F 1/1368; G09G 2310/08; G09G 3/3688; G09G 3/3677; G02F 1/136286

(57) ABSTRACT

A liquid crystal display includes: a first display panel including a transistor; a second display panel disposed facing the first display panel, the second display panel including: a light blocking member overlapping the transistor, the light blocking member including: a first portion having a first thickness; and a second portion having a second thickness; and a liquid crystal layer disposed between the first display panel and the second display panel, wherein the second thickness is thinner than the first thickness.

### CROSS-REFERENCE TO RELATED APPLICATION

This application claims priority from and the benefit of Korean Patent Application No. 10-2019-0052398, filed on May 3, 2019, which is hereby incorporated by reference for all purposes as if fully set forth herein.

### BACKGROUND

### Field

Exemplary embodiments of the invention relate generally to a liquid crystal display and a manufacturing method thereof, and more specifically, to a liquid crystal display and a manufacturing method thereof that may include a light blocking member.

### Discussion of the Background

A liquid crystal display includes two display panels on which field generating electrodes such as pixel electrodes and a common electrode are formed, and a liquid crystal layer filled therebetween. The liquid crystal display generates an electric field in the liquid crystal layer by applying a voltage to the field generating electrodes to determine a direction of liquid crystal molecules of the liquid crystal layer and to control the polarization of incident light, thereby displaying an image.

Among the liquid crystal displays, there is a vertically aligned mode liquid crystal display, in which liquid crystal molecules are aligned so that long axes thereof are perpendicular to upper and lower panels while no electric field is applied. The vertically aligned mode liquid crystal display has been in the limelight because its contrast ratio is high, and a wide reference viewing angle is easily implemented.

The above information disclosed in this Background section is only for understanding of the background of the inventive concepts, and, therefore, it may contain information that does not constitute prior art.

### SUMMARY

Devices constructed and methods according to exemplary embodiments of the invention are capable of providing a liquid crystal display including a light blocking member thinly formed adjacent to a display area to reduce bruising phenomenon, and a manufacturing method thereof.

Additional features of the inventive concepts will be set forth in the description which follows, and in part will be apparent from the description, or may be learned by practice of the inventive concepts.

According to one or more exemplary embodiments of the invention, a liquid crystal display includes: a first display panel including a transistor; a second display panel disposed facing the first display panel, the second display panel including: a light blocking member overlapping the transistor, the light blocking member including: a first portion having a first thickness; and a second portion having a second thickness; and a liquid crystal layer disposed between the first display panel and the second display panel, wherein the second thickness is thinner than the first thickness.

The liquid crystal display may include a light blocking area and an active area, the light blocking area may correspond to an area in which the light blocking member is disposed, the active area may correspond to an area in which the light blocking area is not disposed, and the second portion may be disposed adjacent to the active area.

The second portion may be disposed along a boundary between the active area and the light blocking area, and the second portion may be disposed at respective sides of the first portion in a plan view.

The second portion may be disposed along a boundary between the active area and the light blocking area, and the second portion may be disposed only at one side of the first portion in a plan view.

The first display panel may include: a gate line configured to transmit a gate signal, the gate line including a gate electrode; a semiconductor layer disposed on the gate electrode, the semiconductor layer including a channel; and a data conductor configured to transmit a data signal, the data conductor including a data line including: a source electrode and a drain electrode, and the transistor may include the gate electrode, the semiconductor layer, the source electrode, and the drain electrode, and the second portion of the light blocking member may overlap at least a portion of at least one of the source electrode and the drain electrode.

The first thickness may be 1 μm or more and 1.5 μm or less, and the second thickness may be 0.3 μm or more and 0.8 μm or less.

The second portion may have a first width in a direction parallel to the data line, the first width being 5 μm or more and 10 μm or less.

The liquid crystal display may include pixels, the first display panel may include only one pixel electrode corresponding to each of the pixels, and the pixel electrode may include a horizontal stem portion, a vertical stem portion, and a fine branch portion to form four domains in the each of the pixel areas.

According to the liquid crystal display, a bruising phenomenon may disappear within 2 seconds after the liquid crystal display is pressed.

According to one or more exemplary embodiments of the invention, a liquid crystal display having pixel areas includes: a first display panel including: a first sub-pixel electrode and a second sub-pixel electrode disposed in each of the pixel areas, the first sub-pixel electrode and the second sub-pixel electrode being electrically separated from each other; a first transistor connected to the first sub-pixel electrode, a second transistor connected to the second sub-pixel electrode, and a third transistor connected to the second sub-pixel electrode, the third transistor configured to receive a reference voltage; a second display panel facing the first display panel, the second display panel including: a light blocking member disposed between the first sub-pixel electrode and the second sub-pixel electrode, the light blocking member including: a first portion having a first thickness; and a second portion having a second thickness; and a liquid crystal layer disposed between the first display panel and the second display panel, wherein the second thickness is thinner than the first thickness.

The each of the pixel areas may include: a light blocking area in which the light blocking member is disposed; and an active area which is a portion of the each of the pixel areas that is not the light blocking area, and the second portion may be disposed adjacent to the active area.

The second portion may be disposed along a boundary between the active area and the light blocking area, and the second portion may be disposed at respective sides of the first portion in a plan view.

The second portion may overlap at least one of a portion of the first transistor, a portion of the second transistor, and a portion of the third transistor.

The first thickness may be 1 μm or more and 1.5 μm or less, and the second thickness may be 0.3 μm or more and 0.8 μm or less.

The first display panel may include: a gate line configured to transmit a gate signal; a data line configured to transmit a data signal, the data line being disposed insulated from the gate line and crossing the gate line; and a divided reference voltage line disposed in the same layer as the gate line; the first transistor may be connected to the gate line, the data line, and the first sub-pixel electrode, the second transistor may be connected to the gate line, the data line, and the second sub-pixel electrode, and the third transistor may be connected to the gate line, the second transistor, and the divided reference voltage line.

The second portion may have a first width in a direction parallel to the data line, the first width being 5 μm or more and 10 μm or less.

Each of the first sub-pixel electrode and the second sub-pixel electrode may include a horizontal stem portion, a vertical stem portion, and a fine branch portion to form eight domains in the each of the pixel areas.

According to the liquid crystal display, a bruising phenomenon may disappear within 2 seconds after the liquid crystal display is pressed.

According to one or more exemplary embodiments of the invention, a manufacturing method of a liquid crystal display, including: preparing a substrate; disposing a light blocking material layer on the substrate; and patterning the light blocking member material layer into a light blocking member using a mask, the mask including: a first mask portion having a first light transmittance; and a second mask portion having a second light transmittance, the first light transmittance being smaller than the second light transmittance, wherein the light blocking member includes: a first portion having a first thickness, the first portion corresponding to the first mask portion; and a second portion having a second thickness, the second portion corresponding to the second mask portion, wherein the second thickness is thinner than the first thickness.

The second mask portion may include a slit portion including a plurality of slits.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates a schematic block diagram of a liquid crystal display according to an exemplary embodiment.

FIG. 2 illustrates a plan view of a liquid crystal display according to an exemplary embodiment.

FIG. 3 illustrates a cross-sectional view taken along a sectional line of FIG. 2.

FIG. 4 illustrates a circuit diagram of a liquid crystal display according to another exemplary embodiment.

FIG. 5 illustrates a plan view of a liquid crystal display according to another exemplary embodiment.

FIG. 6 illustrates a cross-sectional view taken along a sectional line VI-VI of FIG. 5.

FIG. 7 shows schematic plan views of simulation of bruising phenomena of a liquid crystal display illustrated with respect to time after applying pressure according to an exemplary embodiment.

FIG. 8, FIG. 9, FIG. 10, and FIG. 11 illustrate schematic cross-sectional views of a substrate for explaining a manufacturing method of a liquid crystal display according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

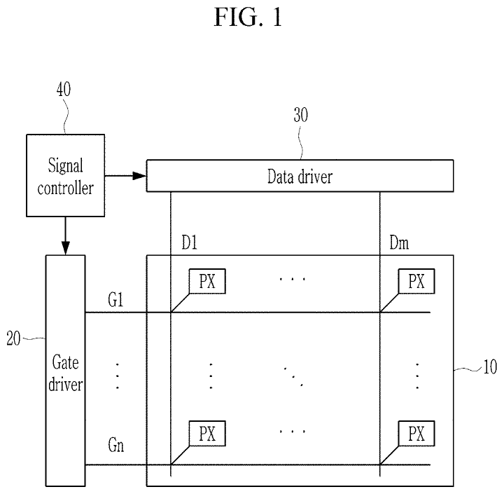

Hereinafter, a display device according to an exemplary embodiment will be described with reference to FIG. 1. FIG. 1 illustrates a schematic block diagram of a liquid crystal display according to an exemplary embodiment.

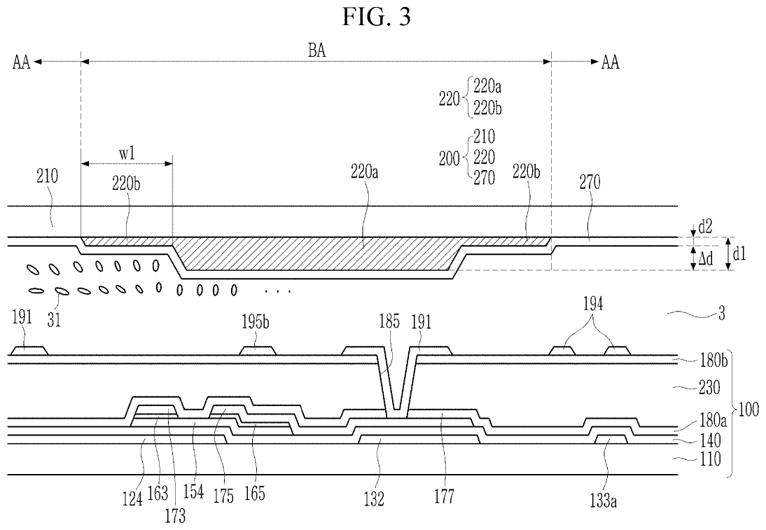

Referring to FIG. 1, a display device according to an exemplary embodiment of the present invention includes a display panel 10, a gate driver 20, a data driver 30, and a signal controller 40. The display panel 10 may include a first display panel 100 (refer to FIGS. 3 and 6) and a second display panel 200 (refer to FIGS. 3 and 6) facing each other and bonded to each other, which will be described later.

The display panel 10 is connected to gate lines G1 to Gn and data lines D1 to Dm, and includes pixels PX substantially arranged in a matrix form. The gate lines G1 to Gn may mainly extend in a first direction (e.g., a row direction), and the data lines D1 to Dm may extend in a second direction (e.g., a column direction) which crosses the first direction. Each pixel PX may receive a gate signal including a gate-on voltage and a gate-off voltage for turning a transistor on and off through the gate lines G1 to Gn, and may receive a data voltage which corresponds to an image signal through the data lines D1 to Dm when the transistor is turned on. The pixel PX is a unit for displaying an image. One pixel uniquely displays one of the primary colors, or a plurality of pixels alternately display the primary colors according to time, thus a desired color may be displayed by a spatial or temporal sum of the primary colors.

The signal controller 40 controls the gate driver 20 and the data driver 30. The signal controller 40 receives an image signal and a control signal for the image signal from an external graphics processor (not shown). The control signal includes, for example, a horizontal synchronization signal, a vertical synchronization signal, a clock signal, a data enable signal, and the like. The signal controller 40 processes the image signal in accordance with an operation condition of the display panel 10 based on the image signal and the control signal, and then generates and outputs image data, a gate control signal, a data control signal, and a clock signal.

The gate driver 20 receives a gate control signal from the signal controller 40, generates a gate signal including a gate-on voltage and a gate-off voltage, and applies the generated gate signal to the gate lines G1 to Gn.

The data driver 30 receives a data control signal and image data from the signal controller 40, converts the image data into a data signal (data voltage) by using a gradation voltage generated by a gradation voltage generator (not shown), and applies the converted data signal to the data lines D1 to Dm.

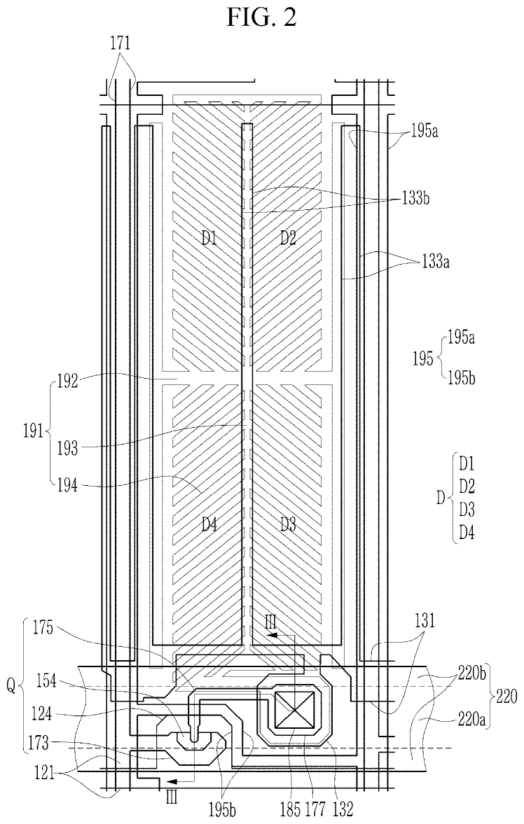

The typical configuration of the liquid crystal display according to the exemplary embodiment has been described so far. Hereinafter, one pixel of the liquid crystal display according to the exemplary embodiment will be described in detail with reference to FIG. 2 and FIG. 3. FIG. 2 illustrates a plan view of a liquid crystal display according to an exemplary embodiment, and FIG. 3 illustrates a cross-sectional view taken along a sectional line of FIG. 2.

Referring to FIG. 2 and FIG. 3, the liquid crystal display according to the exemplary embodiment includes the first display panel 100 and the second display panel 200 facing each other, and a liquid crystal layer 3 disposed therebetween.

First, the first display panel 100 will be described. The first display panel 100 includes a first substrate 110, and a gate conductor, a gate insulating layer 140, a semiconductor layer 154, a data conductor, a first insulating layer 180a, a color filter layer 230, a second insulating layer 180b, and a pixel electrode layer, which are stacked on the first substrate.

The first substrate 110 may be made of a transparent insulating material such as glass.

A gate conductor including a gate line 121, a gate electrode 124, and a storage electrode line 131 is disposed on the first substrate 110.

The gate line 121 substantially extends in a horizontal direction, and transmits a gate signal (also referred to as a scan signal). The gate line 121 may correspond to the gate lines G1-Gn of FIG. 1. Unlike the illustrated embodiment, the gate line 121 may substantially extend in a vertical direction. The gate electrode 124 is integrally formed with the gate line 121, and protrudes from the gate line 121. It is to be understood that integrally formed herein means that they are formed of the same material in the same process and are connected to each other.

The storage electrode line 131 may substantially extend in the horizontal direction and transmit a predetermined voltage such as a common voltage. The storage electrode line 131 may include a first storage electrode line 133a, a second storage electrode line 133b, and a protrusion part 132. The first and second storage electrode lines 133a and 133b may substantially extend to be parallel to the data line 171, and a shape and disposition of the storage electrode line 131 may be variously modified.

The second storage electrode line 133b may overlap a vertical stem portion 193 of a pixel electrode 191 described later. The vertical stem portion 193 may degrade lateral visibility of the liquid crystal display. In this case, since the second storage electrode line 133b overlaps the vertical stem portion 193, the second storage electrode line 133b may serve as a light blocking member in an area overlapping the vertical stem portion 193, thereby preventing or suppressing a light leakage phenomenon and improving lateral visibility.

The second storage electrode line 133b is shown protruding from a portion extending in a horizontal direction of the storage electrode line 131, but in some embodiments, the second storage electrode line 133b may be separately formed from the storage electrode line 131 and may be in a floating state. In other words, the second storage electrode line 133b may be floated and overlap the vertical stem portion 193 of the pixel electrode 191 described later. In some embodiments, the second storage electrode line 133b may be omitted.

The protrusion part 132 may be a part that protrudes from a horizontal side of the storage electrode line 131 in a direction overlapping a portion of a transistor Q described later.

The gate conductor may include a metal such as copper (Cu), molybdenum (Mo), aluminum (Al), silver (Ag), chromium (Cr), or tantalum (Ta), or a metal alloy thereof, and it may be formed as a single layer or a multilayer.

The gate insulating layer 140 is disposed on the gate conductor. The gate insulating layer 140 may include an inorganic insulating material such as a silicon oxide or a silicon nitride.

The semiconductor layer 154 is disposed on the gate insulating layer 140. The semiconductor layer 154 may include a semiconductor material such as an oxide semiconductor, amorphous silicon, or polycrystalline silicon.

Ohmic contacts 163 and 165 may be disposed on the semiconductor layer 154. When the semiconductor layer includes silicon, the ohmic contacts 163 and 165 may include n+ hydrogenated amorphous silicon or a silicide with a high concentration of phosphorus n-type impurities. The ohmic contacts 163 and 165 may be omitted.

A data conductor including a data line 171, a source electrode 173, and a drain electrode 175 is disposed on the ohmic contacts 163 and 165. Although the data line 171 substantially extends in the vertical direction, it may substantially extend in the horizontal direction. The data line 171 may correspond to the data lines D1-Dm of FIG. 1. The source electrode 173 is integrally formed with the data line 171 and protrudes from the data line 171. Unlike the illustrated embodiment, a part of the data line 171 may form the source electrode 173. The drain electrode 175 may be spaced apart from the source electrode 173 by a predetermined distance, and may include an expansion part 177.

In FIG. 2, the first storage electrode line 133a of the storage electrode line 131 and the pixel electrode 191 described later overlap to form a storage capacitor Cst. The expansion part 177 may overlap the protrusion part 132 of the storage electrode line 131. The expansion part 177 and the protrusion part 132 may form the storage capacitor Cst with the gate insulating layer 140 therebetween. Even when a data voltage is not applied to the data line 171, the storage capacitor Cst may serve to maintain a voltage applied to the drain electrode 175 and the pixel electrode 191 connected to the drain electrode 175.

The data conductor may include a metal such as aluminum (Al), copper (Cu), silver (Ag), gold (Au), platinum (Pt), palladium (Pd), nickel (Ni), molybdenum (Mo), tungsten (W), titanium (Ti), chromium (Cr), tantalum (Ta), or the like, or a metal alloy thereof, and it may be formed of a single layer or a multilayer.

The gate electrode 124, the source electrode 173, and the drain electrode 175 form a transistor Q together with the semiconductor layer 154. A channel of the transistor Q may be formed in a portion of the semiconductor layer 154 between the source electrode 173 and the drain electrode 175.

The first insulating layer 180a including an inorganic insulating material such as a silicon oxide (SiOx), a silicon nitride (SiNx), and/or an organic insulating material, and a second insulating layer 180b disposed on the first insulating layer 180a may be disposed on the data conductor. For example, the first insulating layer 180a may include an inorganic insulating material, and the second insulating layer 180b may include an organic insulating material. The first insulating layer 180a and the second insulating layer 180b are disposed on the expansion part 177 of the drain electrode 175, and include an opening 185 overlapping the expansion part 177.

A color filter layer 230 may be disposed between the first insulating layer 180a and the second insulating layer 180b. The color filter layer 230 includes a plurality of color filters that display different colors, and each color filter may include a colorant that indicates a color displayed by the corresponding pixel PX. The second insulating layer 180b may prevent or suppress a material of the color filter layer 230 from leaking into the liquid crystal layer 3.

A pixel electrode layer including the pixel electrode 191 and a shielding electrode 195 is disposed on the second insulating layer 180b. The pixel electrode layer may include a transparent conductive material such as an indium tin oxide (ITO) or an indium zinc oxide (IZO), or a metal such as aluminum, silver, chromium, or an alloy thereof.

The pixel electrode 191 may include a cross-shaped stem portion including a horizontal stem portion 192 and the vertical stem portion 193, and a plurality of fine branch portions 194 protruding therefrom. The pixel electrode 191 may be one electrode that is not separated.

Referring to a lower portion of FIG. 2, domain positions of the fine branch portions 194 of the pixel electrode 191 are shown along an oblique direction. In the present exemplary embodiment, one pixel may include first to fourth domains D1, D2, D3, and D4. The domains are referred to as a first domain D1, a second domain D2, a third domain D3, and a fourth domain D4 in a clockwise direction from a left upper side with respect to the horizontal stem portion 192 of the pixel electrode 191.

The fine branch portions 194 of the pixel electrode 191 are formed to be inclined in different directions in respective areas of the first to fourth domains D1, D2, D3, and D4. The fine branch portions 194 may be formed in the first domain D1 and the second domain D2 in directions inclined to an upper left side and an upper right side, respectively, with respect to the horizontal stem portion 192. In addition, the fine branch portions 194 may be formed in the third domain D3 and the fourth domain D4 in directions inclined to a lower right side and a lower left side, respectively, with respect to the horizontal stem portion 192.

As described above, the domains are divided according to disposition of the fine branch portions 194 of the pixel electrode 191, and arrangement of liquid crystal molecules 31 of the liquid crystal layer 3 described later in each domain may also be changed.

The shielding electrode 195 may include a vertical portion 195a and a horizontal portion 195b. The same voltage as that of a common electrode 270 included in the second display panel 200, which will be described later, is applied to the shielding electrode 195. Since the same voltage is applied to the shielding electrode 195 and the common electrode 270, an electric field is not generated between the shielding electrode 195 and the common electrode 270, and the liquid crystal layer 3 disposed therebetween is not aligned. Accordingly, a liquid crystal between the shielding electrode 195 and the common electrode 270 is in a black state. When the liquid crystal is in a black state, the liquid crystal itself may function as a black matrix (not shown).

In this case, the vertical portion 195a of the shielding electrode 195 may overlap the data line 171 in a direction parallel to the data line 171. The horizontal portion 195b of the shielding electrode 195 may extend from the vertical portion 195a to be disposed in a light blocking area BA in a plan view. The shielding electrode 195 may not be separated for each pixel area but may be connected to all the adjacent pixels to form one electrode.

The liquid crystal layer 3 including the liquid crystal molecules 31 is disposed between the first display panel 100 and the second display panel 200 described later. The liquid crystal layer 3 has negative dielectric anisotropy, and the liquid crystal molecules 31 of the liquid crystal layer 3 are aligned so that their long axes are perpendicular to surfaces of the first and second display panels 100 and 200 in a state in which an electric field does not exist.

The liquid crystal layer 3 includes liquid crystal molecules, and the liquid crystal molecules 31 are arranged in a direction parallel to the fine branch portions 194 of the pixel electrode 191 as an electric field is applied between the pixel electrode 191 and the common electrode 270 of the second display panel 200 described later. Here, since the fine branch portions 194 extend in different directions in the four domains D1, D2, D3, and D4 of the pixel electrode 191, the domain directions of the liquid crystal molecules 31 in the respective four areas are different from each other.

Hereinafter, the second display panel 200 will be described. The second display panel 200 includes a second substrate 210, a light blocking member 220 called a black matrix, and the common electrode 270.

The second substrate 210 may be made of a transparent insulating material such as glass.

The light blocking member 220 may be disposed on the second substrate 210 to prevent or suppress a light leakage phenomenon. The light blocking member 220 may be disposed to overlap at least some of the gate line 121, the data line 171, the transistor Q, the opening 185, and the pixel electrode 191. An area in which the light blocking member 220 is disposed is referred to as a light blocking area BA. In one pixel of FIG. 2, an area that is not blocked by the light blocking member 220, which is not the light blocking area BA, is referred to as an active area AA.

The common electrode 270 is disposed on the light blocking member 220. The common electrode 270 may be made of a transparent conductive material such as an indium tin oxide (ITO), an indium tin oxide (IZO), an indium tin zinc oxide (ITZO), an Al-doped zinc oxide (AZO), and the like. The common electrode 270 may be formed with a whole plate over an entire surface of the second substrate 210. However, the common electrode 270 may be provided with a slit or an opening.

A common voltage provided from the outside may be applied to the common electrode 270 to form an electric field in the liquid crystal layer 3 together with the pixel electrode 191 of the first display panel 100.

Since the light blocking member 220 has a predetermined thickness, a step occurs on the second substrate 210 in a cross-section. In the liquid crystal display according to the exemplary embodiment, as the electric field is applied between the lower pixel electrode 191 and the upper common electrode 270, the liquid crystal molecules 31 that are vertically arranged are inclined along the respective domain directions. As such, since the liquid crystal display displays an image according to the liquid crystal array in the active area AA, control of the liquid crystal array is important.

In a case of a vertically aligned mode (VA mode), the liquid crystal array may be affected not only by an electric field direction between the two electrodes 191 and 270, but also by a step of the plurality of thin film layers respectively formed on the first and second display panels 100 and 200. Accordingly, the liquid crystal molecules 31 are inclined in a direction opposite to the direction of the electric field applied in the active area AA, thus a texture defect may occur on a screen of the liquid crystal display.

Particularly, during pressurization in the VA mode, due to a step of the light blocking member 220 at a boundary between the active area AA and the light blocking area BA and a step in an area in which the opening 185 is formed in the light blocking area BA, the arrangement of the liquid crystal molecules 31 is unstable. A phenomenon of continuing texture failure due to misalignment of liquid crystal over time is called a bruising phenomenon.

Accordingly, in the liquid crystal display according to the exemplary embodiment, the light blocking member 220 is formed to have different thicknesses, thus it is possible to reduce the step at the boundary between the active area AA and the light blocking area BA, thereby preventing or suppressing the misalignment of the liquid crystal and thus preventing or suppressing the bruising phenomenon.

Specifically, the light blocking member 220 includes a first portion 220a and a second portion 220b. The first portion 220a has the first thickness d1 and the second portion 220b has the second thickness d2. The second thickness d2 is thinner than the first thickness d1, and a difference between the first thickness d1 and the second thickness d2 is Δd. When the light blocking member 220 is formed to have a uniform thickness as in the conventional art, the step increases due to the light blocking member 220 at the boundary between the active area AA and the light blocking area BA. Accordingly, the liquid crystal molecules 31 may be misaligned in the opposite direction to the electric field direction between the first and second display panels 100 and 200 at the boundary portion due to the step of the light blocking member 220, so that the bruising may occur. However, in the exemplary embodiment, by forming the thickness of the light blocking member 220 to be thin in an area adjacent to the active area AA, it is possible to prevent or reduce the misalignment of the liquid crystal, thereby improving the display quality by reducing the bruising. Referring to FIG. 3, the first portion 220a is formed to be thinner than the second portion 220b, thereby preventing or reducing the misalignment in which the liquid crystal molecules 31 under the first portion 220a are arranged in a direction opposite to the direction of the electric field.

The first thickness d1 may be from about 1 μm or more and about 1.5 μm or less, and may be, for example, from 1.2 μm or more and 1.3 μm or less. Since a light leakage phenomenon may occur or it may be difficult to bond it to the substrate when the light blocking member 220 is too thin, a proper thickness thereof is required. Accordingly, the second thickness d2 may be from about 0.3 μm or more and about 0.8 μm or less, and more particularly about 0.6 but is not limited thereto.

The first portion 220a of the light blocking member 220 may overlap at least a portion of the transistor Q and at least a portion of the pixel electrode 191 in the light blocking area BA. The first portion 220a may overlap a portion of the source electrode 173 of the transistor Q or may overlap a portion of the expansion part 177 of the drain electrode 175. A first width w1 of the first portion 220a may be about 0.6 μm or more and 1 μm or less, for example about 0.8 μm.

The first portion 220a may be provided at respective sides of the light blocking area BA adjacent to the active area AA in a plan view, or may be provided only at one side thereof.

The disposition of the pixel area, the structure of the transistor and the shape of the pixel electrode are only one example, and the present invention is not limited thereto and various modifications are possible.

Although not shown in FIG. 3, a polarizer may be attached to outer sides of the first substrate 110 and the second substrate 210, respectively.

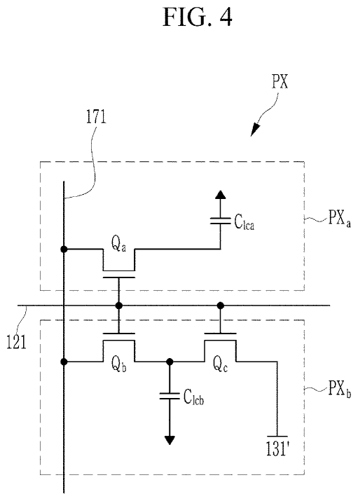

Hereinafter, a liquid crystal display according to another exemplary embodiment will be described with reference to FIG. 4. FIG. 4 illustrates a circuit diagram of a liquid crystal display according to another exemplary embodiment.

Referring to FIG. 4, the pixel PX included in the display device according to the exemplary embodiment of the present invention includes a first sub-pixel PXa and a second sub-pixel PXb. The first sub-pixel PXa includes a first transistor Qa (also referred to as a switching element) connected to at least one data line 171 and at least one gate line 121, and a first liquid crystal capacitor Clca connected to the first transistor Qa. The second sub-pixel PXb includes a second transistor Qb connected to at least one data line 171 and at least one gate line 121, a third transistor Qc (dividing switching element), and a second liquid crystal capacitor Clcb connected between the second transistor Qb and the third transistor Qc.

The first transistor Qa, which is a three-terminal element such as a thin film transistor, includes a gate electrode connected to the gate line 121, a source electrode connected to the data line 171, and a drain electrode connected to the first liquid crystal capacitor Clca. According to a driving method of the present invention, the first transistor Qa may be controlled according to a gate signal transmitted by the gate line 121 to transmit a data voltage transmitted by the data line 171 to the first liquid crystal capacitor Clca.

The second transistor Qb, which is a three-terminal element such as a thin film transistor, includes a gate electrode connected to the gate line 121, a source electrode connected to the data line 171, and a drain electrode connected to the second liquid crystal capacitor Clcb and a source electrode of the third transistor Qc. According to the driving method of the present invention, the second transistor Qb may be controlled according to a gate signal transmitted by the gate line 121 to transmit a data voltage transmitted by the data line 171 to the second liquid crystal capacitor Clcb.

The third transistor Qc, which is a three-terminal element, includes a gate electrode connected to the gate line 121, a source electrode connected to the drain electrode of the second transistor Qb, and a drain electrode connected to a divided reference voltage line 131′. The third transistor Qc is controlled according to a gate signal transmitted by the gate line 121, and when the third transistor Qc and the second transistor Qb are turned on, the data voltage transmitted by the data line 171 is divided by resistance values of the second transistor Qb and the third transistor Qc to be transmitted to the second liquid crystal capacitor Clcb.

The first sub-pixel PXa and the second sub-pixel PXb may display images depending on different gamma curves or display an image depending on the same gamma curve, with respect to one input image signal IDAT. Here, the gamma curve means a curve showing a luminance or transmittance with respect to a gray of the input image signal IDAT.

According to the exemplary embodiment of the present invention, a gamma curve applied to the second sub-pixel PXb may be adjusted by controlling a resistance ratio of the third transistor Qc and the second transistor Qb, a reference voltage, and the like. As such, the luminance of the sub-pixel PXa and the luminance of the sub-pixel Pxb may be different by controlling a charging voltage of the second liquid crystal capacitor Clcb through the control of the third transistor Qc and the reference voltage. When the voltages charged in the first and second liquid crystal capacitors Clca and Clcb are appropriately adjusted, an image viewed from a side surface is as close as possible to an image viewed from a front surface, thereby improving side visibility.

An amount and direction of a leakage current of the third transistor Qc may be adjusted by controlling a first reference voltage or a second reference voltage applied to the plurality of third transistors Qc. This means that a voltage charged in the second liquid crystal capacitor Clcb that is changed depending on its polarity and a luminance of the second sub-pixel PXb may be controlled. For example, even in one frame, the reference voltage applied according to the polarity may be divided into the first reference voltage and the second reference voltage such that uniform brightness may be displayed throughout the display device.

In this case, areas of the first sub-pixel PXa and the second sub-pixel PXb may be the same or different.

In the display device according to the exemplary embodiment of the present invention, the reference voltage may be variously controlled according to the polarity of the data voltage.

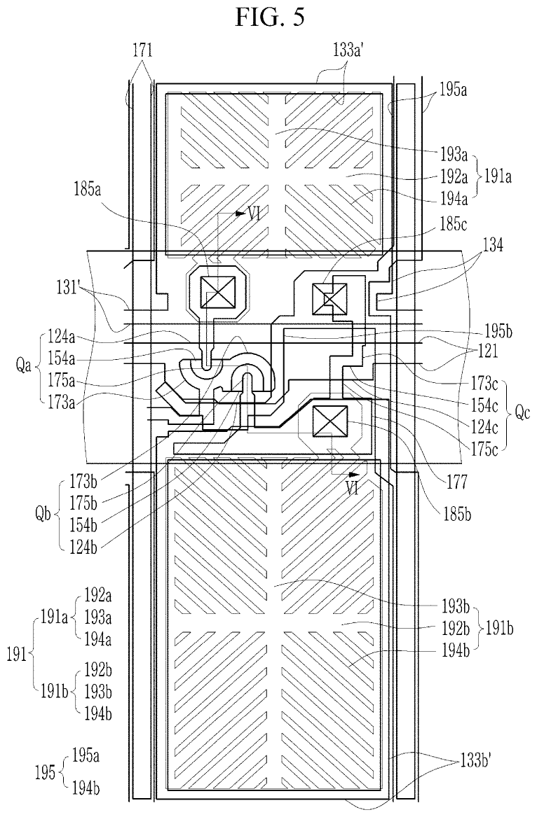

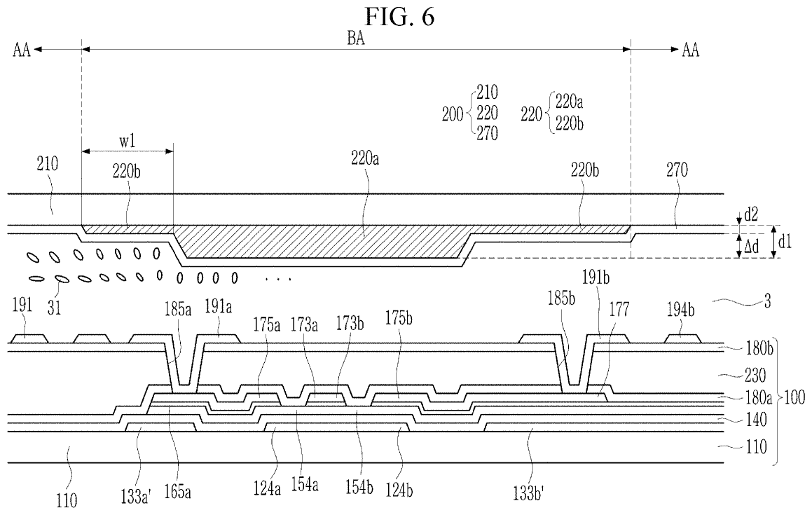

Hereinafter, one pixel of a liquid crystal display according to another exemplary embodiment will be described in more detail with reference to FIG. 5 and FIG. 6. FIG. 5 illustrates a plan view of a liquid crystal display according to another exemplary embodiment, and FIG. 6 illustrates a cross-sectional view taken along a sectional line VI-VI of FIG. 5. Hereinafter, a description of the same or similar elements as those described above may be simplified or omitted.

Referring to FIG. 5 and FIG. 6, the liquid crystal display according to the exemplary embodiment includes the first display panel 100 and the second display panel 200 facing each other, and the liquid crystal layer 3 disposed therebetween.

First, the first display panel 100 will be described. The first display panel 100 includes the first substrate 110, the gate line 121, the data line 171 crossing the gate line 121, transistors (thin film transistors) Qa, Qb, and Qc connected to the gate line 121 and the data line 171, the first and second insulating layers 180a and 180b, the pixel electrode 191, the shielding electrode 195, and the color filter layer 230.

A gate conductor is formed on the first substrate 110 made of transparent glass or plastic. The gate conductor includes a plurality of gate lines 121 and the divided reference voltage line 131′. In some embodiments, the same voltage as the storage voltage may be applied to the divided reference voltage line 131′ and it may be used as the storage electrode line.

The gate line 121 transmits the gate signal, and includes a first gate electrode 124a, a second gate electrode 124b, and a third gate electrode 124c.

The divided reference voltage line 131′ includes a first storage electrode 133a′ and a reference electrode 134. In addition, a second storage electrode 133b′ is connected to the divided reference voltage line 131′ of another pixel disposed under one pixel shown in FIG. 5 and receives the same voltage. The second storage electrode 133b′ is disposed to overlap a second sub-pixel electrode 191b.

The gate insulating layer 140 is disposed on the gate line 121 and the divided reference voltage line 131′.

The semiconductor layer 154 including a first semiconductor 154a, a second semiconductor 154b, and a third semiconductor 154c is disposed on the gate insulating layer 140. The semiconductor layer 154 includes source and drain regions doped with impurities, and a channel region not doped with an impurity. The source region and the drain region are regions corresponding to first, second, and third source electrodes 173a, 173b, and 173c and first, second, and third drain electrodes 175a, 175b, and 175c to be described later.

The semiconductor layer 154 may include amorphous silicon (a-Si) or polycrystalline silicon (poly-Si).

A plurality of ohmic contacts 163 and 165 may be disposed on the semiconductor layer 154, but may be omitted.

The data conductor is disposed on the ohmic contacts 163 and 165 and the gate insulating layer 140. The data conductor includes a plurality of data lines 171 including the first source electrode 173a and the second source electrode 173b, the first drain electrode 175a, the second drain electrode 175b, the third drain electrode 175c, and the third source electrode 173c. The second drain electrode 175b and the third drain electrode 175c may be connected to each other through the expansion part 177 to be integrally formed.

The data conductor, the semiconductor layer 154 disposed under the data conductor, and the ohmic contacts 163 and 165 may be simultaneously formed by using a single mask.

The first gate electrode 124a, the first source electrode 173a, and the first drain electrode 175a form the first transistor Qa together with the first semiconductor 154a, and a channel of the first transistor Qa is formed in the first semiconductor 154a between the first source electrode 173a and the first drain electrode 175a.

Similarly, the second gate electrode 124b, the second source electrode 173b, and the second drain electrode 175b form the second transistor Qb together with the second semiconductor 154b, and a channel of the second transistor Qb is formed in the second semiconductor 154b between the second electrode 173b and the second drain electrode 175b.

The third gate electrode 124c, the third source electrode 173c, and the third drain electrode 175c form the third transistor Qc together with the third semiconductor 154c, and a channel of the third transistor Qc is formed in the third semiconductor 154c between the third source electrode 173c and the third drain electrode 175c. The third source electrode 173c includes a portion overlapping the shielding electrode 195 through a third opening 185c and receives the reference voltage.

The first insulating layer 180a may be disposed on the data conductor. The first insulating layer 180a may include an inorganic insulating film such as a silicon nitride or a silicon oxide. The first insulating layer 180a may prevent or suppress a pigment of the color filter layer 230 from flowing into an exposed portion of the semiconductor layer 154.

The color filter layer 230 is disposed on the first insulating layer 180a. The color filter layer 230 may extend in the vertical direction along two data lines 171 adjacent to each other.

The second insulating layer 180b is formed on the color filter layer 230. The second insulating layer 180b may include an inorganic insulating material such as a silicon nitride or a silicon oxide, or an organic insulating material. The second insulating layer 180b may be omitted. The second insulating layer 180b prevents or suppresses the color filter layer 230 from being lifted and suppresses the liquid crystal layer 3 from being polluted due to an organic material, such as a solvent inflowing from the color filter layer 230, thereby preventing or suppressing defects such as an afterimage which may occur at the time of driving the screen from occurring.

The first insulating layer 180a, the color filter layer 230, and the second insulating layer 180b are provided with a first opening 185a, a second opening 185b, and the third opening 185c for exposing the first drain electrode 175a, the expansion part 177 of the second drain electrode 175b, and the third source electrode 173c, respectively.

The pixel electrode layer including the pixel electrode 191 and the shielding electrode 195 is disposed on the second insulating layer 180b.

The pixel electrode 191 includes a first sub-pixel electrode 191a and the second sub-pixel electrode 191b that are separated from each other with the gate line 121 therebetween, and that are adjacent to each other in a column direction based on the gate line 121. The pixel electrode 191 may be made of a transparent material such as ITO and IZO.

The first sub-pixel electrode 191a and the second sub-pixel electrode 191b have an overall quadrangular shape, and include a cross-shaped stem portion consisting of horizontal stem portions 192a and 192b and vertical stem portions 193a and 193b crossing the horizontal stem portions 192a and 192b, and fine branch portions 194a and 194b extending therefrom. The first sub-pixel electrode 191a and the second sub-pixel electrode 191b include the horizontal stem portions 192a and 192b and the vertical stem portions 193a and 193b crossing the horizontal stem portions 192a and 192b, respectively, thus in the present exemplary embodiment, one pixel may have eight domains.

The first sub-pixel electrode 191a and the second sub-pixel electrode 191b are physically and electrically connected to the first drain electrode 175a and the second drain electrode 175b through the first opening 185a and the second opening 185b, respectively, and receive the data voltage from the first and second drain electrodes 175a and 175b. In this case, a portion of the data voltage applied to the second drain electrode 175b is divided through the third source electrode 173c such that a voltage applied to the first sub-pixel electrode 191a is larger than a voltage applied to the second sub-pixel electrode 191b.

The first sub-pixel electrode 191a and the second sub-pixel electrode 191b to which the data voltage is applied generate an electric field together with the common electrode 270 of the second display panel 200, thereby determining the alignment of liquid crystal molecules of the liquid crystal layer 3 between the two electrodes 191 and 270. Luminance of light passing through the liquid crystal layer 3 varies depending on the determined alignment of the liquid crystal molecules.

The first sub-pixel electrode 191a and the first storage electrode 133a′ overlap each other to form a first storage capacitor Csta, and the second sub-pixel electrode 191b and the second storage electrode 133b′ overlap each other to form a second storage capacitor Cstb.

The above-described divided reference voltage line 131′, and the first storage electrode 133a′ and the second storage electrode 133b′ extending from the divided reference voltage line 131′, form a storage capacitor, and they serve to block light leakage that may occur between the adjacent pixel areas, between the pixel electrode 191 and the data line 171, and so on.

The shielding electrode 195 includes the vertical portion 195a disposed in a vertical direction and the horizontal portion 195b disposed in a horizontal direction. The same voltage as that of the common electrode 270 formed on the second display panel 200, which will be described later, is applied to the shielding electrode 195. Since the same voltage is applied to the shielding electrode 195 and the common electrode 270, an electric field is not generated between the shielding electrode 195 and the common electrode 270, and the liquid crystal layer 3 disposed therebetween is not aligned.

In this case, the vertical portion 195a of the shielding electrode 195 may overlap the data line 171 in a direction parallel to the data line 171. The horizontal portion 195b of the shielding electrode 195 may extend from the vertical portion 195a to be disposed between the first sub-pixel electrode 191a and the second sub-pixel electrode 191b.

The liquid crystal layer 3 including the liquid crystal molecules 31 is disposed between the first display panel 100 and the second display panel 200. The liquid crystal molecules 31 are tilted in respective domain directions depending on the arrangement of the pixel electrodes 191 to form domains.

Hereinafter, the second display panel 200 will be described. The second display panel 200 includes the second substrate 210, the light blocking member 220, and the common electrode 270.

The light blocking member 220 is disposed on the second substrate 210, which may be made of transparent glass or plastic. The area in which the light blocking member 220 is formed is referred to as the light blocking area BA, and the area excluding the light blocking area BA in one pixel is referred to as the active area AA.

The light blocking member 220 has a thinner thickness at a portion adjacent to the active area AA than the inside of the light blocking area BA. That is, the light blocking member 220 includes the first portion 220a and the second portion 220b having different thicknesses. The first portion 220a has the first thickness d1, the second portion 220b has the second thickness d2, and the second thickness d2 is thinner than the first thickness d1 by the thickness difference Δd.

The light blocking member 220 may be formed to be thinner at a portion adjacent to the active area AA to minimize a step by the light blocking member 220 at a boundary between the active area AA and the light blocking area BA. Accordingly, it is possible to control the liquid crystal so as to minimize the misalignment of the liquid crystal molecules 31 in the active area AA, thereby preventing or suppressing the bruising due to the defective texture.

The first thickness d1 may be about 1 μm or more and about 2 μm or less, for example from 1.2 μm or more and 1.3 μm or less. When the light blocking member 220 is too thin, a light leakage phenomenon may occur, or it may be difficult to bond it to the substrate, so a proper thickness thereof is required. Accordingly, the second thickness d2 may be about 0.3 μm or more and about 1 μm or less, and particularly, it may be about 0.6 μm.

The first portion 220a of the light blocking member 220 may overlap at least a portion of the transistors Qa, Qb, and Qc and at least a portion of the pixel electrode 191 in the light blocking area BA. The first portion 220a may overlap at least a portion of the first drain electrode 175a of the first transistor Qa, at least a portion of the third source electrode 173c, and at least a portion of the second drain electrode 175b. The first width w1 of the first portion 220a may be about 0.6 μm or more and 1 μm or less, for example about 0.8 μm.

The first portion 220a may be provided at respective sides of the light blocking area BA adjacent to the active area AA in a plan view, or may be provided only at one side thereof. Although not shown in FIG. 6, a polarizing plate may be attached to the outer sides of the first substrate 110 and the second substrate 210, respectively.

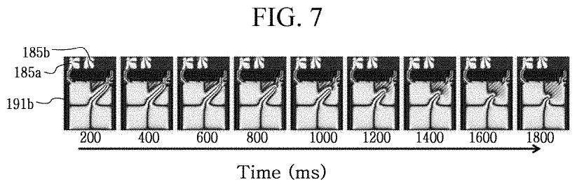

Hereinafter, effects of a liquid crystal display according to an exemplary embodiment will be described with reference to FIG. 7. FIG. 7 shows schematic plan views of simulation of bruising phenomena of a liquid crystal display illustrated with respect to time after applying pressure according to an exemplary embodiment.

Referring to FIG. 7 together with FIG. 5, the light blocking area BA including the second sub-pixel electrode 191b, the first opening 185a, and the second opening 185b in one pixel of the display device according to the exemplary embodiment is shown. In respective plan views, it can be seen that the liquid crystal forms four domains depending on the arrangement of the fine branch portions 194b of the second sub-pixel electrode 191b.

When the respective plan views are viewed from the left side according to the flow of time (ms), it can be confirmed that the liquid crystal is shifted to an upper right domain among the four domains when the first 200 ms passes. When a defective texture occurs due to the shifted misalignment of the liquid crystal, a dark portion may appear on a screen to be viewed as stained. It can be seen that the liquid crystal shifted to the upper right domain gradually returns to the normal arrangement as a time (ms) flows to the right side. When an elapsed time reaches about 1.4 s to about 1.8 s, the texture defect gradually disappears, thus the bruising phenomenon may be reduced.

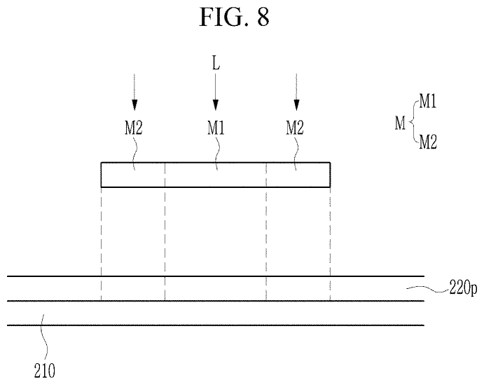

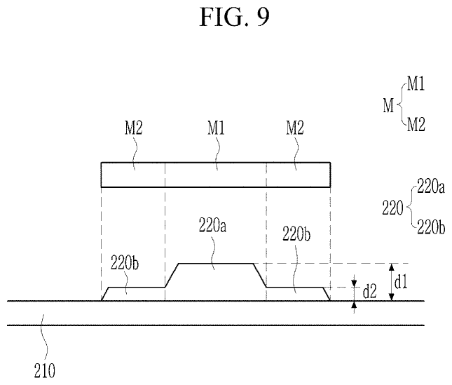

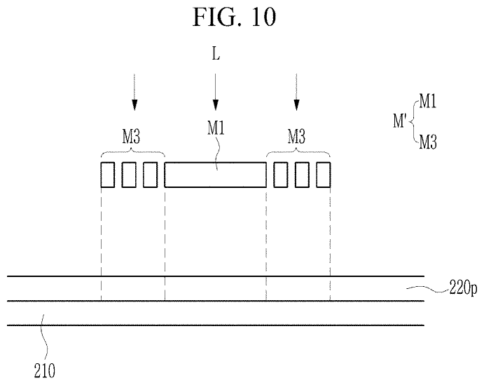

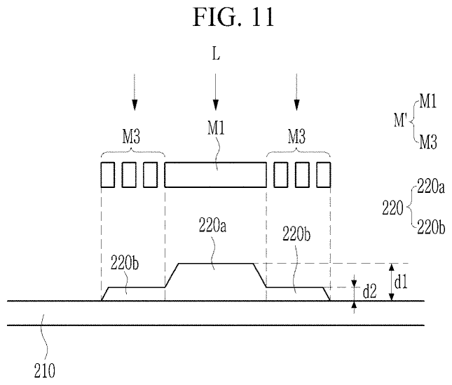

Hereinafter, the liquid crystal display according to the exemplary embodiment will be described in more detail with reference to FIG. 8 to FIG. 11. FIG. 8, FIG. 9, FIG. 10, and FIG. 11 illustrate schematic cross-sectional views of a substrate for explaining a manufacturing method of a liquid crystal display according to an exemplary embodiment.

Referring to FIG. 8, a light blocking member material layer 220p for forming the light blocking member is applied on the second substrate 210. The light blocking member 220 of FIG. 9 may be formed by irradiating a laser beam L using a mask M to pattern the light blocking member material layer 220p.

The mask M may include a first mask portion M1 and a second mask portion M2 having different transmittances of the laser beam L. The transmittance of the laser beam (light) L of the second mask portion M2 is greater than that of the first mask portion M1. For example, the transmittance of the light L of the first mask portion M1 may be 0% and the transmittance of the light L of the second mask portion M2 may exceed 0%, thus the light L may pass through the second mask portion M2 so that the corresponding light blocking member material layer 220p may be exposed. Alternatively, some of the light blocking member material layer 220p in which the mask M is not disposed is 100% exposed by the light L to be eliminated.

FIG. 9 illustrates the light blocking member 220 formed according to the patterning process of FIG. 8. The light blocking member 220 includes the first portion 220a having the first thickness d1 and the second portion 220b having the second thickness d2. Since the transmittance of the light L of the second mask portion M2 is greater than that of the first mask portion M1, the light blocking member material layer 220p of FIG. 8 corresponding to the second mask portion M2 is patterned thinner to form the second portion 220b. The light blocking member material layer 220p of FIG. 8 corresponding to the first mask portion M1 is patterned to form the first portion 220a. The second thickness d2 is thinner than the first thickness d1.

As such, by patterning the light blocking member material layer using the mask M including the first and second portions M1 and M2 having different transmittances, the light blocking member 220 may be formed to have different thicknesses for respective areas, and thus the bruising phenomenon may be reduced.

In the present exemplary embodiment, it is shown that the second mask portion M2 is provided at respective sides of the first mask portion M1 in a plan view, but the second mask portion M2 may be provided only at one side thereof.

Hereinafter, a manufacturing method of a liquid crystal display according to another exemplary embodiment will be described with reference to FIG. 10 and FIG. 11. A description of the same or similar elements as those of the exemplary embodiments of FIG. 8 and FIG. 9 described above may be simplified or omitted.

Referring to FIG. 10, the light blocking member 220 of FIG. 11 is formed by using a slit mask M′. Unlike the mask M described above, the slit mask M′ is provided with slit portions M3 at respective sides of the first mask portion M1 in a plan view. The slit portion M3 includes a plurality of slits, and the transmittance of the light L of the slit portion M3 is greater than that of the first mask portion M1.

Referring to FIG. 11, the light blocking member 220 includes the first portion 220a and the second portion 220b. The light blocking member material layer 220p of FIG. 10 corresponding to the first mask portion M1 is formed as the first portion 220a, and the light blocking member material layer 220p of FIG. 10 corresponding to the slit portion M3 is formed as the second portion 220b. Since the transmittance of the light L of the slit portion M3 is greater than that of the first mask portion M1, the second thickness d2, which is the thickness of the second portion 220b, is thinner than the first thickness d1, which is the thickness of the first portion 220a.

As such, by performing the patterning process using the slit mask M′ including the first and second portions M1 and M2 having different transmittances, the light blocking member 220 may be formed to have different thicknesses for respective areas, and thus the bruising phenomenon may be reduced in the liquid crystal display.

In the present exemplary embodiment, the slit portion M3 is provided at respective sides of the first mask portion M1 in a plan view, but it may be provided only at one side thereof.

According to the exemplary embodiments, the liquid crystal display may have improved display quality by providing a light blocking member with a dual step structure to reduce bruising phenomenon.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display comprising:
a first display panel comprising a transistor;
a second display panel disposed facing the first display panel, the second display panel comprising: a light blocking member overlapping the transistor, the light blocking member comprising:
a first portion having a first thickness; and
a second portion having a second thickness; and
a liquid crystal layer disposed between the first display panel and the second display panel,
wherein the second thickness is thinner than the first thickness.

2. The liquid crystal display of claim 1, wherein the liquid crystal display comprises a light blocking area and an active area,
wherein the light blocking area corresponds to an area in which the light blocking member is disposed,
wherein the active area corresponds to an area in which the light blocking area is not disposed, and
wherein the second portion is disposed adjacent to the active area.

3. The liquid crystal display of claim 2, wherein the second portion is disposed along a boundary between the active area and the light blocking area, and
wherein the second portion is disposed at respective sides of the first portion in a plan view.

4. The liquid crystal display of claim 2, wherein the second portion is disposed along a boundary between the active area and the light blocking area, and
wherein the second portion is disposed only at one side of the first portion in a plan view.

5. The liquid crystal display of claim 1, wherein the first display panel comprises:
a gate line configured to transmit a gate signal, the gate line comprising a gate electrode;
a semiconductor layer disposed on the gate electrode, the semiconductor layer comprising a channel; and
a data conductor configured to transmit a data signal, the data conductor comprising a data line comprising: a source electrode and a drain electrode, and
wherein the transistor comprises the gate electrode, the semiconductor layer, the source electrode, and the drain electrode, and
wherein the second portion of the light blocking member overlaps at least a portion of at least one of the source electrode and the drain electrode.

6. The liquid crystal display of claim 1, wherein the first thickness is 1 μm or more and 1.5 μm or less, and the second thickness is 0.3 μm or more and 0.8 μm or less.

7. The liquid crystal display of claim 5, wherein the second portion has a first width in a direction parallel to the data line, the first width being 5 μm or more and 10 μm or less.

8. The liquid crystal display of claim 1, wherein the liquid crystal display comprises pixels,
wherein the first display panel comprises only one pixel electrode corresponding to each of the pixels, and
wherein the pixel electrode comprises a horizontal stem portion, a vertical stem portion, and a fine branch portion to form four domains in the each of the pixels.

9. The liquid crystal display of claim 1, wherein a bruising phenomenon disappears within 2 seconds after the liquid crystal display is pressed.

10. A liquid crystal display having pixel areas, the liquid crystal display comprising:
a first display panel comprising:
a first sub-pixel electrode and a second sub-pixel electrode disposed in each of the pixel areas, the first sub-pixel electrode and the second sub-pixel electrode being electrically separated from each other;
a first transistor connected to the first sub-pixel electrode,
a second transistor connected to the second sub-pixel electrode, and
a third transistor connected to the second sub-pixel electrode, the third transistor configured to receive a reference voltage;
a second display panel facing the first display panel, the second display panel comprising: a light blocking member disposed between the first sub-pixel electrode and the second sub-pixel electrode, the light blocking member comprising:
a first portion having a first thickness; and
a second portion having a second thickness; and
a liquid crystal layer disposed between the first display panel and the second display panel,
wherein the second thickness is thinner than the first thickness.

11. The liquid crystal display of claim 10, wherein the each of the pixel areas comprises:
a light blocking area in which the light blocking member is disposed; and
an active area which is a portion of the each of the pixel areas that is not the light blocking area, and
the second portion is disposed adjacent to the active area.

12. The liquid crystal display of claim 11, wherein the second portion is disposed along a boundary between the active area and the light blocking area, and
wherein the second portion is disposed at respective sides of the first portion in a plan view.

13. The liquid crystal display of claim 11, wherein the second portion overlaps at least one of a portion of the first transistor, a portion of the second transistor, and a portion of the third transistor.

14. The liquid crystal display of claim 10, wherein the first thickness is 1 μm or more and 1.5 μm or less, and the second thickness is 0.3 μm or more and 0.8 μm or less.

15. The liquid crystal display of claim 10, wherein the first display panel comprises:
a gate line configured to transmit a gate signal;
a data line configured to transmit a data signal, the data line being disposed insulated from the gate line and crossing the gate line; and
a divided reference voltage line disposed in the same layer as the gate line;
wherein the first transistor is connected to the gate line, the data line, and the first sub-pixel electrode,
wherein the second transistor is connected to the gate line, the data line, and the second sub-pixel electrode, and
wherein the third transistor is connected to the gate line, the second transistor, and the divided reference voltage line.

16. The liquid crystal display of claim 15, wherein the second portion has a first width in a direction parallel to the data line, the first width being 5 μm or more and 10 μm or less.

17. The liquid crystal display of claim 10, wherein each of the first sub-pixel electrode and the second sub-pixel electrode comprises a horizontal stem portion, a vertical stem portion, and a fine branch portion to form eight domains in the each of the pixel areas.

18. The liquid crystal display of claim 10, wherein a bruising phenomenon disappears within 2 seconds after the liquid crystal display is pressed.

19. A manufacturing method of a liquid crystal display, comprising:
preparing a substrate;
disposing a light blocking material layer on the substrate; and
patterning the light blocking member material layer into a light blocking member using a mask, the mask comprising:
a first mask portion having a first light transmittance; and
a second mask portion having a second light transmittance, the first light transmittance being smaller than the second light transmittance,
wherein the light blocking member comprises:
a first portion having a first thickness, the first portion corresponding to the first mask portion; and
a second portion having a second thickness, the second portion corresponding to the second mask portion, and
wherein the second thickness is thinner than the first thickness.

20. The manufacturing method of the liquid crystal display of claim 19, wherein the second mask portion comprises a slit portion comprising a plurality of slits.
